(19) United States
(12) Patent Application Publication
(10) Pub. No.: US 2022/0081343 A1
(43) Pub. Date: Mar. 17, 2022

(54) METHOD AND APPARATUS FOR CUTTING GLASS SHEETS

(71) Applicant: SCHOTT AG, Mainz (DE)

(72) Inventors: Michael Waschbüsch, Undenheim (DE); Volker Plapper, Alzey (DE); Klaus-Peter Kurek, Mainz (DE); Ulrich Engelhardt, Hannover (DE)

(73) Assignee: SCHOTT AG, Mainz (DE)

(21) Appl. No.: 17/447,776

(22) Filed: Sep. 15, 2021

(30) Foreign Application Priority Data
Sep. 15, 2020 (DE) 10 2020 123 928.9

(51) Int. Cl. C03B 33/02; C03B 33/023; C03B 33/033; C03B 33/03; B23K 26/00; B23K 26/53; B23K 26/0622

(52) U.S. Cl. CPC C03B 33/0222; C03B 33/0235; C03B 33/033; C03B 33/03; B23K 2103/54; B23K 26/53; B23K 26/0624; C03B 2225/02; B23K 26/0006

(57) ABSTRACT

A method is provided that includes providing a glass sheet of a thickness of at most 300 μm and irradiating the glass sheet with a pulsed laser beam. The laser beam has a light intensity inside the glass sheet leaves a filamentary damage along its path through the glass sheet. The laser beam and the glass sheet are moved relative to each other so that due to the pulses of the laser beam filamentary damages are inserted next to one another along a path running on the glass sheet. During the insertion of the filamentary damages, a tensile stress is applied on the glass at the filamentary damages and in the direction transverse to the path of the adjacent filamentary damages so that the glass sheet separates along the path during insertion of the filamentary damages.

### CROSS REFERENCE TO RELATED APPLICATIONS

This application claims benefit under 35 USC § 119 of German Application No. 10 2020 123 928.9 filed Sep. 14, 2021, the entire contents of which are incorporated herein by reference.

### BACKGROUND

### 1. Field of the Invention

The invention generally relates to the cutting of thin glasses. In particular, the invention relates to a method and an apparatus for cutting glasses with laser irradiation.

### 2. Description of Related Art

Separation of thin glass is standardly carried out with conventional scoring and breaking processes. These processes have at least two stages. First, a scratching tool, such as a scratching wheel or a diamond, is used to insert a superficial damage and subsequently the glass pane is separated along the superficial damage by mechanical bending or the introduction of thermomechanical stresses, for example by means of a CO₂ laser.

A cutting process in which a crack is inserted using a diamond or a similarly shaped carving tool is known from DE 10 2018 131 179 A1. Very firm edges can be produced with this process. On the other hand, diamonds, as scoring tools, are very sensitive and can be damaged especially when placed on the glass.

Laser-induced tension-crack-separation is known from US 2013/0 126 576 A1, WO 2011/026 074 A1 and U.S. Pat. No. 6,327,875 B1. These processes are generally unstable for thin glasses, since it is difficult to build up a sufficiently large temperature gradient between the top and bottom of the glass. Furthermore, even the smallest temperature gradients lead to unstable three-dimensional distortions (“humps”). WO 2016/156 235 A1 proposes an asymmetric beam profile to obtain a steeper temperature gradient. Similarly, WO 2016/156 234 A provides a special beam profile in which two subareas of the laser's field of action are spaced laterally to the dividing line, and frame a section in the field of action through which the dividing line runs, such that areas of the thin glass next to the dividing line and in the section of this spacing will be heated to a greater extent than areas on the dividing line.

Further, DE 10 2017 100 015 A1 discloses a method for separating a glass substrate, in which damages are inserted into the substrate at a distance from one another along a predetermined separating line with a pulsed laser beam, wherein both the mean distance between neighboring damages as well as the number of laser pulses to generate one damage each are selected in such a way that the breaking stress for separating the substrate is smaller than a reference stress, and whereby the edge strength of the separating edge, which is obtained after separation, is greater than a second reference stress which depends on the respective substrate. The substrate can be separated along the separation line by applying a tension after the damage has been inserted. In particular with thin substrates, however, there is the problem that a glass substrate whose strength has already been weakened by the perforation can be separated in an undefined manner during handling (e.g. transport). As a result, the separation can take place in an uncontrolled manner with regard to the edge contour and, as a result, may also result in reduced edge strength. The reason is that thin glass, due to its low inherent stiffness, tends to deform under the forces of handling and thus inadvertently higher tensile stresses can be inserted than required for cutting. In particular, if these stresses do not act along the pre-prepared line, but deviate at an angle to it, uncontrolled breakage or reduced edge strength may occur.

### SUMMARY

It is therefore an object of the invention to enable a reliably separation of even thin glasses in a stable process.

Accordingly, a method for separating glass sheets is provided, in which a glass sheet of a thickness of at most 300 μm is provided, and the glass sheet is irradiated with a pulsed laser beam of an ultra-short pulse laser, the light intensity of the laser beam inside the glass sheet is so high, that the laser beam leaves a filamentary damage along its path through the glass sheet, and the laser beam and the glass sheet are moved relative to each other so that due to the pulses of the laser beam filamentary damages are inserted next to one another along a path running on the glass sheet, and wherein during the insertion of the filamentary damages, a tensile stress acting on the glass at the filamentary damages and preferably in the direction transverse, in particular perpendicular to the path of the adjacent filamentary damages is applied to at least one surface of the glass sheet, so that the glass sheet separates along the path during insertion of the filamentary damages.

Preferably, the thickness of the glass sheets is at most 200 μm, more preferably at most 100 μm. In particular, the invention can also be applied to very thin glass sheets with a thickness of 50 μm or less, in particular at most 35 μm. In one embodiment, a glass sheet with a thickness of 30 μm is processed.

A glass sheet is to be understood as a very thin glass pane, which has a low inherent stiffness due to its small thickness.

It is preferred, if the laser beam has a wavelength for which the glass of the glass sheet is transparent, such that the laser beam can traverse the glass sheet.

Furthermore, the laser beam can be focused with a focusing optics. Thereby, due to the focusing, the light intensity of the laser beam inside the glass sheet may become high enough that the laser beam leaves a filamentary damage along its path through the glass sheet.

The application of the tensile stress during the insertion of the filamentary damages can be an application of the tensile stress simultaneously with the insertion of a filament. In general, however, the tensile stress can be applied in a period of time that overlaps with the time period of the insertion of the plurality of filaments, so that the insertion of the filaments and the application of the tensile stress takes place simultaneously during this temporal overlap.

For the sake of simplicity, the filamentary damages will in the following simply be referred to as filaments. The filamentary damage may be a continuous, thin, open channel. As well, only a filament-shaped or rather linearly shaped change in material may be present. Mixed kinds are also possible in which cavities or material changes extend along a line. For example, one kind may comprise short damages which are lined up along a line in a chain-like manner and which are generated by periodic self-focusing of an intense laser beam.

Surprisingly, it was found that the processes of perforating or rather pre-damaging with the pulses of an ultra-short pulse laser can be carried out in direct succession with the separation and thus, these processes can be combined in a common process step in a defined manner. Thereby, the perforation is carried out on the glass while the glass of the glass sheet is subjected to a defined tensile stress. By combining the tensile stress with the perforation and the resulting pre-weakening, the substrate may, directly in one setting or configuration, be weakened in a defined manner and directly separated. Thereby, the usual and required edge quality from established separation processes may be achieved in one step with ultrashort pulse lasers.

The crack jumps from one filament to the next, in particular under the influence of tensile stress, typically as soon as a new filament has been inserted. Thereby, not only the usual two-tier nature of the separation with scratching and subsequent breaking is eliminated. Since the crack moves successively from filament to filament, it is also avoided that the crack overtakes the row of filaments, as far as they have already been inserted, and then continues to propagate in an uncontrolled manner. This enables good control of the course of the crack.

If the glass sheet is bent to generate a tensile stress directed transversely to the path, an especially good control of the crack propagation will be achieved. For this purpose, the glass sheet is placed on a support with a protrusion such that the glass sheet bends over the protrusion. Preferably, the protrusion is elongated, wherein the path of the lined up filaments runs along the longitudinal direction of the protrusion.

The separation of the glass sheet may in particular also be used to tailor glass elements with desired dimensions. Thereby, preprocessing may be carried out by separating the glass sheets from a glass ribbon. Then, the separation edges produced in the cause of the separation from the glass ribbon do not have to be of high quality.

For example, the separation edges do not have to run strictly at right angles to the edge of the glass ribbon. Since the separation line strictly follows the path of the filaments lined up one behind the other, then, a high degree of shape accuracy is achieved due to the laser-supported separation. Accordingly, in one embodiment of the method it is provided, that a continuous glass ribbon is produced in a hot forming process, wherein glass sheets being separated from the glass ribbon, and wherein glass elements being detached from the glass sheets by inserting and lining up filamentary damages.

A particular benefit of the method described herein is the use of straight dividing lines, as well as intersecting dividing lines. Basically, curved dividing lines (corner radii) are also conceivable.

### DESCRIPTION OF THE DRAWINGS

In the following, the invention is explained in more detail with reference to the accompanying drawings.

FIG. 1 shows an apparatus for separating a pane of glass.

FIG. 2 shows a variant of the arrangement shown in FIG. 1.

FIG. 3 shows a further variant of the arrangement shown in FIG. 1 with a transport device for the glass sheet.

FIG. 4 shows a glass sheet separated from a glass ribbon.

In FIG. 5, a glass sheet with two paths of perforations with different starting points is shown.

FIG. 6 shows a glass sheet with two intersecting paths of the laser beam.

FIGS. 7a-7c are different beam profiles of a laser beam.

FIGS. 8 to 11 show further embodiments of apparatuses for separating glass sheets.

### DETAILED DESCRIPTION

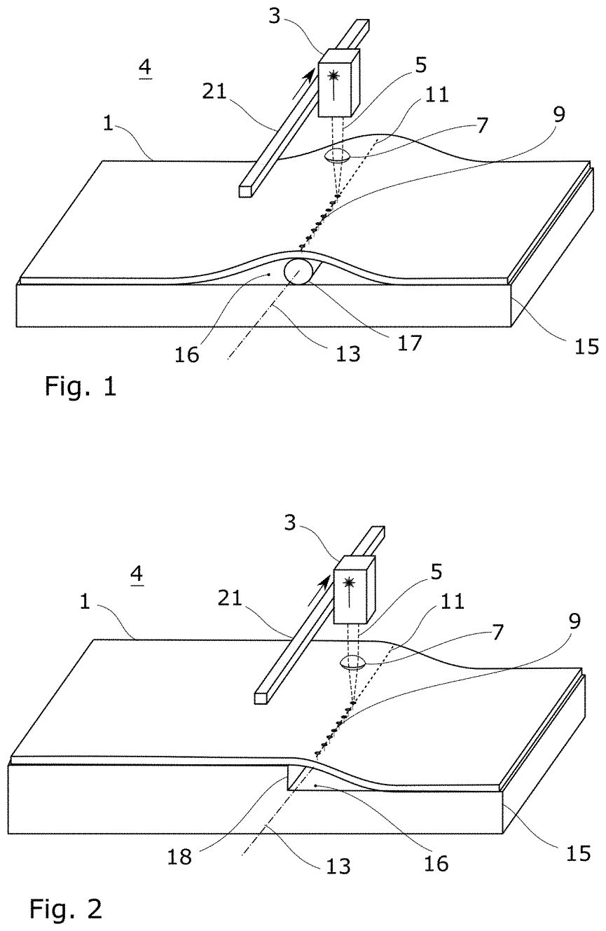

In FIG. 1 an apparatus 4 for carrying out the method described herein is shown. In general, without being restricted to the specific example shown, the apparatus 4 for separating glass sheets 1 with a thickness of at most 300 μm, comprises an ultrashort pulse laser 3 for irradiating a glass sheet 1 with a pulsed laser beam 5, wherein the laser beam 5 has a wavelength for which the glass is transparent, so that the laser beam 5 can traverse the glass sheet 1, as well as a focusing optics 7 to focus the laser beam 5, so that the light intensity of the laser beam 5 inside the glass sheet 1 becomes so high that the laser beam 5 leaves a filamentary damage 9 along its path through the glass sheet 1, and a device 21 to move the laser beam 5 and glass sheet 1 relative to each other, such that the pulses of the laser beam 5 insert filamentary damages 9 next to one another along a path 11 running on the glass sheet 1, as well as a device for exerting tensile stress on the glass sheet 1 during the insertion of the filamentary damages 9, wherein the tensile stress acts on the glass at the filamentary damages 9 and in the direction transverse to the path 11 of the adjoining filamentary damages 9, such that the glass sheet 1 separates along the path 11 during the insertion of the filamentary damages 9.

According to one embodiment, the ultrashort pulse laser 3 may be operated in a so-called burst mode. In this operating mode, the laser pulse is not emitted as a single pulse, but as a sequence of pulses emitted in quick succession, which together form a pulse package, a so-called burst. The pulse frequency within a burst is significantly higher than the repetition frequency of the bursts. Such a pulse package usually has a slightly higher energy than a single pulse in a usual single-shot operation. The pulses of a burst however, contain significantly less energy than a single pulse. The energies of the pulses within a burst do not have to be constant, but may also decrease or increase. A suitable laser for the purposes of the method described herein is a neodymium-doped yttrium-aluminum-garnet laser, operated, for example, at a wavelength of 1064 nanometers. According to one embodiment, the ultrashort pulse laser 3 is operated with a repetition rate in the range from 1 kHz to 1000 kHz, preferably in the range from 10 kHz to 400 kHz, most preferably in the range from 30 kHz to 200 kHz.

The repetition rate and scanning speed with which the laser beam 5 is moved along the provided path 11 over the glass sheet 1 may be selected such that the desired distance between adjacent filamentary damages 9, also referred to as “pitch”, is achieved. The suitable pulse duration of a laser pulse is in a range of less than 100 picoseconds, preferably less than 20 picoseconds. The typical average power of the ultrashort pulse laser 3 is preferably in a range from 50 to 500 watts. According to an advantageous development of the invention, a pulse energy in the burst of more than 400 microjoules is used in order to generate the filamentary damages 9 in the glass, furthermore advantageously a total burst energy of more than 500 microjoules.

The filamentary damages 9 preferably are spaced to one another in a distance, that is to say in a pitch in the range from 1 μm to 10 μm, preferably from 3 μm to 8 μm.

During operation of the pulse laser 3 in the burst mode, the repetition rate is the repetition rate of the release of bursts. Typically, the pulse duration is essentially independent of whether a laser is operated in single pulse mode or in burst mode. The pulses of a burst thus generally have a similar pulse length to a pulse in single-pulse mode. The frequency of the individual pulses within a burst may be in the range from 15 MHz to 90 MHz, preferably in the range from 20 MHz to 85 MHz and is, for example, 50 MHz. The number of pulses of the burst may be between 2 and 10 pulses, e.g. 6 pulses. Preferred repetition rates, that is to say the rates at which the bursts repeat, are in the range from 50 to 500 kHz.

As in the example shown, the apparatus 4 preferably comprises a support 15 on which the glass sheet 1 is placed. The support 15 may have a support surface 16 with a protrusion, such that the glass sheet 1 bends over the protrusion. A tensile stress is generated by the bending of the glass sheet 1 over the protrusion.

According to one embodiment, the support 15 comprises a support surface 16 on which a rod 17 is placed, the rod 17 forming an elongated protrusion over which the placed glass sheet 1 bends.

The bending of the glass sheet 1 over the protrusion, such as the rod 17 for example, results in an axis of curvature 13, which extends in the longitudinal direction of the protrusion. The direction of the tensile stress on the glass surface caused by the bend extends transversely, in particular perpendicular to the axis of curvature 13 and thus also transversely to the longitudinal axis of the protrusion.

The apparatus 21 for moving the laser beam 5 and the glass sheet 1 relative to each other is symbolized in FIG. 1 by a traverse on which the ultrashort pulse laser 3 is moved over the glass sheet 1 together with the focusing optics 7. As an alternative or in addition to a movement of the laser, it is also possible to move the glass sheet 1 relative to a stationary laser beam 5 in order to guide the laser beam 5 along the provided path 11 over the surface of the glass sheet 1. In order to achieve a spontaneous, controlled separation of the glass sheet 1 along the predefined path 11 of filamentary damages 9, which are lined up, the path 11, and thus also the direction of movement of the laser beam 5 over the surface of the glass sheet 1, runs along the longitudinal direction of the protrusion, or more generally, along the axis of curvature 13 of the bend of the glass sheet 1. Due to the bend over the rod 17, the axis of curvature 13 of the bend is also parallel to the longitudinal axis of the rod 17 or, more generally, of the elongated protrusion.

By insertion of the perforation made of filaments 9 lined up in a row along the tensile stress line generated by the bending, the glass sheet 1 is immediately separated in the perforation process step. A separation can also take place if the geometric bending line and the perforation line deviate from one another within the scope of customary manufacturing tolerances. Preferably, the deviation is in the range of less than 1 mm, preferably less than 0.5 mm, particularly preferably less than 0.3 mm.

It is advantageous to create a defined bend, which is ensured by placing it on a correspondingly shaped support. Furthermore, it is generally favorable when the laser beam 5 strikes the glass largely orthogonally in order to form the perforation or rather the laser filament in the glass. Preferably, the deviation of the direction of incidence from the vertical to the surface is preferably less than 5°.

It is assumed that the breakage occurring during the separation jumps along the path 11 from one filamentary damage 9 to the next filamentary damage 9. This ensures that the break cannot overtake the laser beam 5, which is guided over the glass sheet 1, since the break stops at the last filament 9 inserted due to the lack of another filament positioned ahead. If the break would overtake the row of successively inserted filaments, an uncontrolled course of the break edge could arise due to the lack of guidance along the filaments.

One parameter in the context of the separating process described herein is the tensile stress in the glass sheet 1, which is applied, for example, by rods 17 of different diameters. A round rod with D=6 mm with a 30 μm-thick glass of type AS87 may therefore lead to a maximum tensile stress of 360 MPa, which exceeds the usual separation strengths (typically 15-35 MPa depending on the laser process) by one order of magnitude. Adjusting the laser line and the mechanical bending in one step leads to a controlled separation process for very thin glass.

In general, without limitation to the shown example or even just the generation of tensile stress by bending, according to an embodiment, it is provided that a tensile stress is generated on the glass sheet 1 in the region of the path 11 on at least one surface of the glass sheet 1, which is at least 75 MPa, preferably at least 150 MPa, most preferably at least 250 MPa. On the other hand, a tensile stress, which is too high, may be disadvantageous, since it could lead to a spontaneous break. Preferably, the maximum tensile stress exerted on the glass sheet 1 is at most 750 MPa.

The following table lists exemplary embodiments with which the influence of the diameter of the rod 17 on the quality of the separating edge produced in the glass sheet 1 was investigated:

| Test | Diameter of | Quality of the | |
|---|---|---|---|
| No. | the rod [mm] | break edge | Comments |
| 1 | 2 | Good | |
| 2 | 2 | Good | |
| 3 | 2 | Bad | Lateral Offset (2 mm) |
| 4 | 2 | Bad | Lateral Offset (1 mm) |
| 5 | 2 | Good | |
| 6 | 2 | Moderate | |
| 7 | 2 | Moderate | |
| 8 | 3 | Very Good | |
| 9 | 3 | Good | |
| 10 | 3 | Good | |
| 11 | 4 | Very Good | |
| 12 | 4 | Good | |
| 13 | 6 | Good | |
| 14 | 6 | Very Good | |
| 15 | 6 | Very Good | |
| 16 | 8 | Good | |
| 17 | 8 | Very Good | |

The experiments have been carried out on glass sheets 1 with a thickness of 30 μm made of AS87-glass. According to the results listed in the table, optimal edges are achieved with a rod-diameter of 6 mm.

According to an alternative or additional embodiment, the glass sheet 1 is bent over a step 18 in the support 15, wherein the filamentary damages 9 being inserted along a path 11, which runs along the step 18. Due to the slope of the substrate on the step 18, it is subjected to a defined tensile stress. According to this embodiment, FIG. 2 shows a variant of the apparatus 4 according to FIG. 1. Such an arrangement may be advantageous in order to successively separate the glass sheet 1 in parallel cuts by moving the glass sheet 1 forward over the step 18 after a separation process with a further separation carried out subsequently.

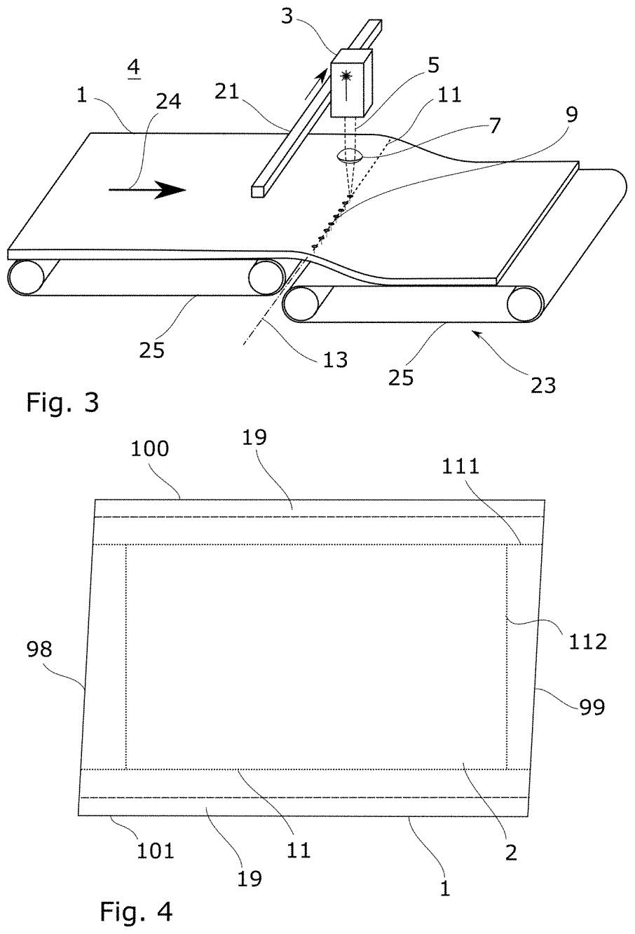

FIG. 3 shows a further variant of the arrangement shown in FIG. 1 with a feed or transport device 23 with which the glass sheet 1 is moved. The principle of this embodiment is based on the fact that the transport device 23 being designed such that the glass sheet 1 is bent on the transport device 23, wherein the axis of curvature 13 of the bending of the glass sheet 1 being oriented transverse, in particular perpendicular, to the feed direction 24 of the transport apparatus 23. The bending of the glass sheet 1 is achieved in particular by the arrangement and design of the various transport elements. The example shown in FIG. 3 comprises two conveyor belts 25 as transport elements. These are arranged at different levels so that, similar to the embodiment shown in FIG. 2, a step is formed over which the glass sheet 1 runs.

FIG. 4 illustrates a typical application of the method. The method, or apparatus 4 for carrying out the method, respectively, may be used to remove glass elements 2 from glass sheets 1. Thereby, the glass sheet 1 has beads 19, which represent thickened edge areas on two opposite sides. Such glass sheets 1 are obtained when they are separated as sections from a glass ribbon, wherein the glass ribbon being produced in a continuous hot-forming process. In a preferred embodiment, the glass ribbon is produced in a down-draw process, in which the glass ribbon is drawn off from a nozzle opened downwards. The beads 19 are generated due to the soft glass, which is still hot tending to contract after being drawn off from the nozzle. This contraction occurs primarily at the edge of the glass ribbon. As a result of the edgings 19, the glass sheet 1 has a higher rigidity when bent with an axis of curvature 13 crossing the beads 19 than in the case of a bend with an axis of curvature 13 parallel to the longitudinal direction of the beads 19.

The method may in particular be used to produce glass elements 2, which are precisely defined in terms of shape and dimensions. As can be seen in FIG. 4, the edges 98, 99 of the glass sheet 1 that cross the beads 19 are not exactly at right angles to the edges 100, 101 with the beads. Such glass sheets 1 may be obtained in particular if the glass sheets 1 are separated from a continuous glass ribbon by inserting short scores only at the edge of the glass ribbon. The edges 98, 99 are then generated by breaks in the glass ribbon starting at the scores, which therefore do not necessarily run perfectly at right angles to the two longitudinal edges of the glass ribbon. On the other hand, this pre-cut method allows a fast, coarse cut and thus a high feed rate of the glass ribbon. Therefore, without being limited to the examples described herein, in one embodiment of the method it is provided that a continuous glass ribbon is produced in a hot forming process, wherein the glass sheets 1 being separated from the glass ribbon by inserting scores at the edge of the glass ribbon and wherein the glass sheets 1 are separated by breaks starting from the cracks and severing the glass ribbon transversely. Then, as described, glass elements 2 may be separated from the glass sheets 1 by inserting and lining up filamentary damages 9 along one or more predetermined paths 11.

In the example shown in FIG. 4, the path 11 running in the outer contour of the glass sheet 1 is divided into smaller paths or sections 111, 112. The path 11 as a whole encompasses the contour of a glass element 2 to be removed from the glass sheet 1. In order to facilitate the bending of the glass sheet 1 to generate the tensile stress for the separation during the perforation with the laser beam 5, it is generally advantageous if the glass sheet 1 is separated first at sections 111 running along the beads 19 and then at sections 112 extending transversely to the beads 19. That is to say, the glass sheet 1 can easily be bent over a protrusion extending parallel to the beads 19, while in the case of a protrusion crossing the beads 19, the very stiff beads 19 would also have to be bent.

Preferably, the sections 111 running along the beads 19 are guided over at least one of the edges of the glass sheet 1. In the example shown, the two sections 111 even run over both transverse edges 98, 99 of the glass sheets 1. If the beads 19 are separated, the glass sheet 1 may then also be easily bent in the direction perpendicular thereto. Without being limited to the example shown, one embodiment generally provides that a glass sheet 1 is provided, which comprises two opposing edges 100, 101 that comprise beads 19 in the form of thickened areas extending along these edges, wherein the glass sheet 1 is first separated along two paths 111, which extend in the direction of the edges 100, 101 with the beads 19, and wherein the glass sheet 1 is then separated along at least one further path 112, which runs transversely to the two paths 111 in the direction of the edges. Preferably, the separation also takes place, as shown, along two paths 112 running transversely to the edges 100, 101 with the beads 19. The paths 111 in the direction of the edges 100, 101 with the beads 19 preferably run parallel to these edges 100, 101.

Depending on the desired shape of the glass element 2 separated in this way, these paths may, however, also have a certain angle to the edges. In this case, the paths 112 or their extensions, however, preferably do not cross the beads 19 in order to avoid that the beads 19 would also have to be bent in order to generate the tensile stress. Likewise, as shown in FIG. 4 the paths 112 running transversely to the edges 100, 101 with the edgings 19 run perpendicular to the edges 100, 101. Using paths 111 or 112, one running parallel and one running perpendicular, a rectangular glass element 2 is separated from the glass sheet 1 in this way.

In order to achieve a stable process guidance, it is generally advantageous if the tensile stress at the cut edges of the glass sheet 1, such as a section of a glass ribbon with beads 19, does not exceed the edge strength present there, so that no uncontrolled break occurs. The edge strength can be determined by breaking tests on samples produced in a similar way. The mean value of the tensile stresses at which the samples break may be used as the edge strength. In general, without being limited to the examples shown in the figures, it is therefore provided that the glass sheet 1 is subjected to a tensile stress, which is lower than the mean value of the tensile stress, that is to say the mean breaking stress under which the glass sheet 1 tears at one edge. Preferably, the tensile stress exerted does not exceed a value in the order of ⅔, preferably half of the mean breaking stress.

In the process with the ultrashort pulse laser, there may in particular be two versions of the method. These variants of the method are explained in more detail with reference to FIG. 5. FIG. 5 shows a glass sheet 1 with two paths 111, 112 of perforations, that is to say lined up filamentary damages 9. The two paths 111, 112 differ with regard to their starting points 113. According to one embodiment of the method, the path of the laser beam crosses two opposing edges 100, 101 of the glass sheet 1. The perforation (laser line or path 11) is therefore introduced continuously over the edges of the glass sheet 1, i.e. with a forward-stroke and a follow-up. Possibly, however, depending on the cutting process, the stresses at the edge of the raw glass sheet 1 or the glass sheet 1 may be undefined, so that the break starts in an undefined manner. However, this continuous perforation implemented in the example of the path 111 is favorable in order to produce a continuous, well-defined separating edge.

A further possibility is the applied perforation implemented with the path 112. Accordingly, the starting point 113 of the path 112 of the laser beam is positioned on the glass sheet 1 and is thus spaced to all edges of the glass sheet 1 in a certain distance. Therefore, the perforation (laser line or path 11) is started within the glass sheet 1 at the beginning and preferably runs with a corresponding follow-up only. Then, the first section, which is not perforated in this case, surprisingly, generally separates by itself and in a controlled manner due to the breaking mechanism that occurs in the remaining area under the tensile stress. According to one embodiment, the distance to the nearest edge is 1-2 mm. Preferably, the laser beam is then guided at the end over one of the edges of the glass sheet 1, so that the path 112 of the laser beam accordingly crosses one of the edges, in this case the edge 101.

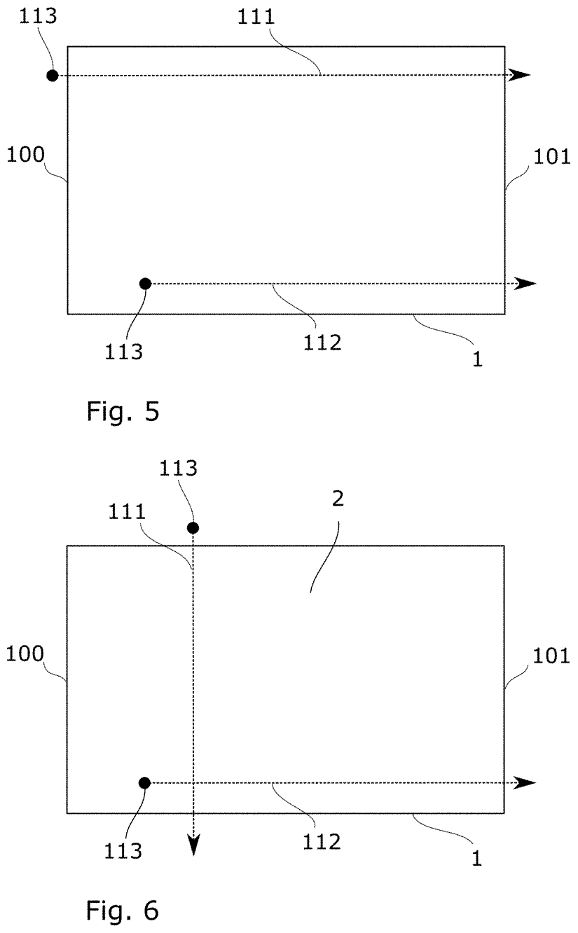

Both embodiments may also be combined, in particular both forms of paths 111, 112 may be inserted. In this way, a first discontinuous cut with a starting point on the glass may be inserted. A second path crossing two opposing edges may then cross the non-continuous cut or path and thus separate a glass element 2. This embodiment is shown in FIG. 6. In this case, it is thus not necessary for the glass sheet 1 to break spontaneously between the starting point 113 of the path 112 and the edge 100.

The separability of the glass sheet 1 and thus the tensile stress to be applied may be influenced by several parameters, such as the pitch, that is to say the mutual spacing of the filamentary damages 9. One possibility to reduce the tensile stress is to set a specific beam profile of the laser beam 5. According to one embodiment, a focusing optics 7 is provided for this purpose, which generates a beam profile of the laser beam 5 in the glass sheet 1, which is larger in the direction along the path 11 than in the direction perpendicular to the path. By irradiating the glass sheet 1 with a laser beam 5 with such a beam profile, preferred directions of microcracks may be generated, which facilitate the separability or allow a separation at a lower tensile stress.

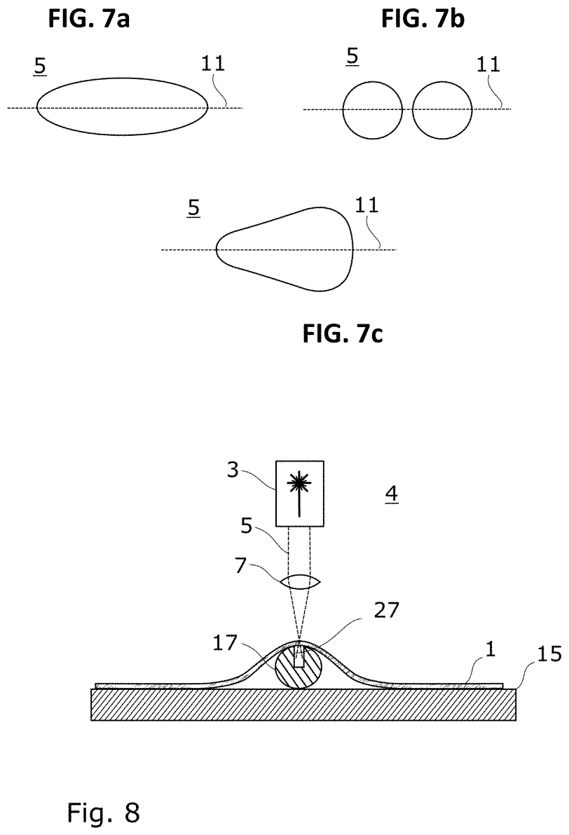

Without loss of generality, FIGS. 7a-7c show examples of different beam profiles of the laser beam 5, which, as described above, are more extended in the direction of the path 11 than perpendicular thereto. FIG. 7a shows a laser beam 5 with an elliptical beam profile whose long semiaxis is oriented in the direction of the path 11. In beam profile according to FIG. 7b, the beam profile is split into two separate spots, the two spots being spaced apart in the direction along the path 11. Due to this distance, the beam profile is also more extended in the direction of the path 11 than perpendicular thereto. It is also possible to provide a beam profile, which is asymmetrical with respect to a mirror axis perpendicular to the path 11. Related to this, an example is shown in FIG. 7c. The beam profile has the shape of a drop elongated along the path 11. Elongated beam profiles, such as exemplarily shown in FIGS. 7a-7c, may facilitate the separation, in particular also in the case of non-straight paths 11.

FIGS. 8 to 10 show further embodiments of apparatuses 4 for separating glass sheets 1. FIG. 8 is a variant of the example shown in FIG. 1. FIG. 8 is an example of an embodiment in which a support 15 with an elongated protrusion is provided, wherein the protrusion having an interruption in the area of the point of incidence of the laser beam 5, such that the glass sheet 1 positioned on the support 15 is exposed at the point of incidence of the laser beam 5. In the example of FIG. 8, the interruption is implemented by a groove 27 in the rod 17. The glass sheet 1 spans over this groove 27. In this way, the laser beam 5 does not directly strike the rod 17 after it has traversed the glass sheet 1. This avoids damage to the rod 17.

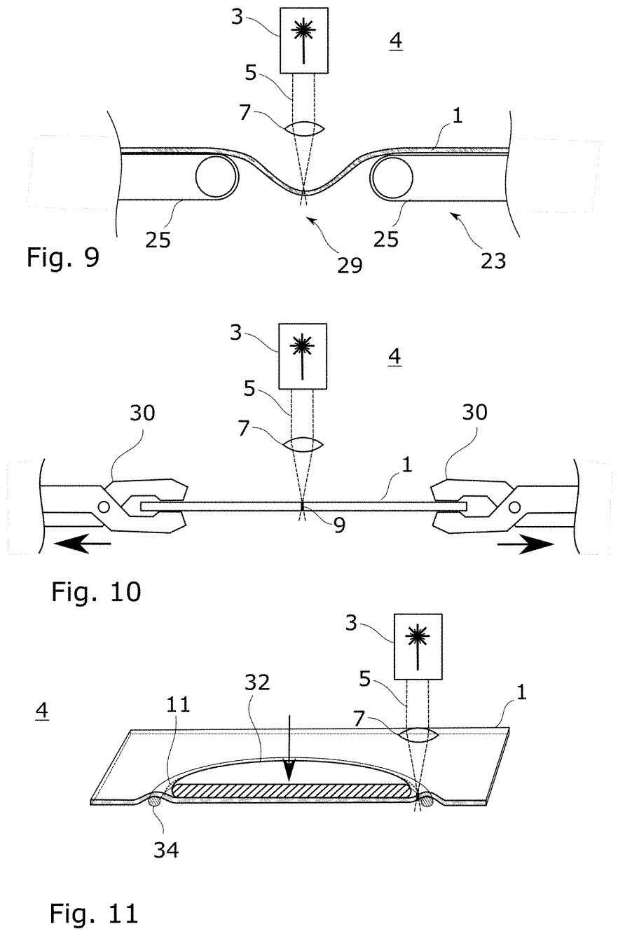

In the exemplary embodiments shown so far, the bending of the glass sheet 1 generates the tensile stress on the side of the glass sheet 1 facing the ultrashort pulse laser 3 or the direction of incidence of the laser beam 5. However, it is also generally possible to bend the glass sheet 1 such that a tensile stress is generated on the side of the glass sheet 1 facing away from the ultrashort pulse laser 3. FIG. 9 shows an example thereof. In general, without being limited to the shown example, in one embodiment, it is provided, that the side of the glass sheet 1 facing the ultrashort pulse laser 3 being bent in a concave manner. In order to achieve this, a support 15 with a gap 29 may generally be provided, wherein the glass sheet 1 arches into the gap 29. In the shown example, a support 15 in the form of a transport or feed apparatus 23 with two conveyor belts 25 separated by a gap 29 is provided. The glass sheet 1 sags at the gap 29 and, as a result, arches into it.

One advantage of this embodiment is that the tensile stress is distributed over a wide area of the opposite side of the glass sheet 1 when the glass sheet 1 sags due to its own weight, so that the arrangement is less sensitive to the position of the path 11 or to the point of incidence of the Laser beam 5. This way, non-straight paths or separating edges may also be implemented in a simple manner. By moving the conveyor belts 25 or, more generally, the movement devices in opposite directions, there is also the possibility of adjusting the bending radius of the glass sheet 1 and thus the tensile stress. However, in this case the vertical position of the glass sheet 1 also changes in relation to the laser beam 5.

In the embodiments described so far with reference to the figures, the tensile stress was generated on at least one surface of the glass sheet 1 by bending the glass sheet 1. When bending, a tensile stress is generated on the convexly curved side, while a compressive stress is produced on the opposite, concavely curved side. However, it is also possible to pull on the glass sheet 1 in order to generate a tensile stress. Then, the tensile stress is applied to both opposing sides. It is evident to the skilled person that pulling on the glass sheet 1 expediently takes place in the direction transverse, preferably perpendicular, to the path of the filaments.

FIG. 10 shows an apparatus for carrying out this embodiment. A pulling device 30 (symbolized in the figure by two gripping pliers) is provided, which pulls on the glass sheet 1 transversely to the path 11, so that a tensile stress is produced on both opposing surfaces of the glass sheet 1.

FIG. 11 shows, in a cut-away perspective view, another variant of an apparatus 4 for separating open glass sheets 1. With this apparatus 4, the glass sheet 4 may be separated along a non-linear path 11. In general, this apparatus is based on using a stamp 32 and a protrusion, wherein the stamp 32 and the protrusion being offset from one another and are brought together, wherein the glass sheet 1 is bent between these elements, which are brought together. In the shown example, the stamp 32 is plate-shaped and the protrusion is a ring 34. This generates an annular tensile stress zone, wherein the tensile stress acts in radial direction along the glass surface. This way, the glass sheet 1 may be separated along a generally ring-shaped path 11, for example along a circular path as shown.

It is evident to the skilled person skilled that the method and the apparatus are not restricted to the specific exemplary embodiments described here, but that they may be modified within the scope of the subject matter of the following claims. In particular, different exemplary embodiments may also be combined with one another. For example, a transport apparatus 23, as provided in FIG. 3, may also be provided in the example of FIG. 1. The rod 17 may generally also be a passively or actively rotatable roller. Also, the example with the stamp 32 and the annular protrusion to produce non-linear contours of glass elements is also exemplary. Likewise, in relation to the aforementioned example, other possibilities are possible, such as the application of a low pressure to generate a tensile stress acting along at least one glass surface.

### REFERENCE SYMBOLS

1 glass sheet
2 glass element
3 ultra-short pulse laser
4 apparatus for separating glass sheets
5 laser beam
7 focusing optics
9 filamentary damage
11, 111, 112 path
13 axis of curvature
15 support
16 support surface
717 rod
18 step
19 edging
21 device to move
23 transport apparatus
24 feed direction
25 conveyor belts
27 groove
29 gap
30 pulling device
32 stamp
34 ring
98, 99, 100, 101 edges of the glass sheet
113 starting point of the path 11, 111, 112

What is claimed is:

1. A method for separating glass sheets, comprising:
providing a glass sheet with a thickness of at most 300 μm;
irradiating the glass sheet is irradiated with a laser beam of an ultra-short pulse laser, the laser beam having an intensity inside the glass sheet that leaves a filamentary damage along a laser path through the glass sheet;
moving, during the irradiating step, the laser beam and the glass sheet relative to one another in a separation path so that, due to pulses of the laser beam, the filamentary damage comprises a plurality of damages next to one another along the separation path; and
applying, during the irradiating and moving steps, a tensile stress on a least one surface of the glass sheet at the plurality of damages in a direction transverse to the separation path so that the glass sheet separates along the separation path.

2. The method of claim 1, wherein the tensile stress causes a break in the glass sheet at a first filamentary damage of the plurality of damages to jump to a second filamentary damage of the plurality of damages along the separation path.

3. The method of claim 1, wherein the step of applying the tensile stress comprises bending the glass sheet in a direction transverse to the separation path.

4. The method of claim 3, wherein the step of bending comprises a step selected from a group consisting of:
placing the glass sheet on a support with a protrusion such that the glass sheet bends over the protrusion;
placing the glass sheet on a support surface on which a rod is positioned along the separation path such that the glass sheet bends over the rod;
placing the glass sheet on a support surface having a step along the separation path such that the glass sheet bends over the step;
using, during the moving step, a transport device configured to bend the glass sheet.

5. The method of claim 1, wherein the step of providing the glass sheet comprises:
hot forming a continuous glass ribbon; and
separating the glass sheet from the continuous glass ribbon.

6. The method of claim 5, wherein the step of separating the glass sheet from the continuous glass ribbon comprises the steps of irradiating, moving, and applying.

7. The method of claim 1, wherein the step of applying the tensile stress comprises a pulling the glass sheet transversely to the separation path so that the tensile stress is produced on opposing surfaces of the glass sheet.

8. The method of claim 1, wherein the tensile stress is at least 75 MPa and at most 750 MPa.

9. The method of claim 8, wherein the tensile stress is at least 150 MPa.

10. The method of claim 8, wherein the tensile stress is at least 250 MPa.

11. The method of claim 1, wherein the tensile stress is at least 75 MPa and at most ⅔ of a mean breaking stress of the glass sheet at an edge of the glass sheet.

12. The method of claim 11, wherein the tensile stress is at most ½ of the mean breaking stress.

13. The method of claim 1, wherein the step of moving comprises moving so that the separation path crosses two opposite edges of the glass sheet.

14. The method of claim 1, wherein the step of moving comprises moving so that a starting point of the separation path is positioned on the glass sheet, the starting point being spaced from all edges of the glass sheet.

15. The method of claim 1, wherein the step of irradiating comprises irradiating so that the laser beam has a beam profile in the glass sheet that is longer in a direction along the separation path than in a direction perpendicular to the separation path.

16. The method of claim 1, wherein the step of providing the glass sheet comprises providing the glass sheet having two opposing edges with beads thereon that are thickened areas extending along the two opposing edges, wherein the separation path comprises two paths extending along the two opposing edges so that the glass sheet is separated from the thickened areas.

17. The method of claim 16, wherein the separation path further comprises a third path running transverse to the two paths.

18. An apparatus for separating a glass sheet, comprising:
an ultrashort pulse laser configured to irradiate the glass sheet with a pulsed laser beam, wherein the ultrashort pulse laser generates the pulsed laser beam with a wavelength for which glass of the glass sheet is transparent so that the laser beam traverses the glass sheet;
a focusing optics configured to focus the laser beam so that a light intensity of the laser beam inside the glass sheet is sufficient to leave filamentary damages along a laser path through the glass sheet;
a moving device configured to generate relative movement between the laser beam and the glass sheet such that the pulses of the laser beam insert the filamentary damages next to one another along a separation path on the glass sheet;
a tensile stress inducing device configured to exerting a tensile stress on the glass sheet during the insertion of the filamentary damages and in a direction transverse to the separation path so as to separate the glass sheet along the separation path.

19. The apparatus of claim 18, wherein the tensile stress inducing device comprises a device selected from a group consisting of:
a support having a protrusion, the support being configured and position to support the glass sheet thereon with the protrusion bending the glass sheet over the protrusion to generate the tensile stress;
a support having a step, the support being configured and position to support the glass sheet thereon with the step bending the glass sheet over the step to generate the tensile stress;
a feed device that bends the glass sheet with an axis of curvature transverse a feed direction of the feed device; and
a pulling device that pulls on the glass sheet transversely to the separation path so that the tensile stress is produced on opposing surfaces of the glass sheet.

20. The apparatus of claim 18, wherein the focusing optics are configured to generate a beam profile of the laser beam in the glass sheet that is longer in a direction along the separation path than in a direction perpendicular to the separation path.
